(19) United States
(12) Patent Application Publication
(10) Pub. No.: US 2007/0188384 A1
(43) Pub. Date: Aug. 16, 2007

(54) Co-construction with antenna and EMI shield

(75) Inventor: I-Ru Liu, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/353,037

(22) Filed: Feb. 14, 2006

(51) Int. Cl. H01Q 1/38

(52) U.S. Cl. 343/700 MS

(57) ABSTRACT

A co-construction with an antenna function and an EMI shielding function is electrically connected with a printed circuit board (PCB). A radio frequency circuit having a high frequency element is disposed on the PCB. The co-construction includes a shield and a first antenna. The shield has a first hole. The first antenna has a first radiator, a first ground point and a first feeding point. The first ground point is electrically connected to the first radiator and shield respectively. The first feeding point extends from one side of the first radiator and passes through the shield via the first hole to electrically connect to the radio frequency circuit of the PCB.

### BACKGROUND OF THE INVENTION

1. Field of Invention

The invention relates to a co-construction and, in particular, to a co-construction with an antenna and an EMI shield.

2. Related Art

In a wireless transmission system, the antenna is an important component used to transmit and/or receive the electromagnetic wave. In other words, if there were no antenna, the wireless transmission system could not transmit and receive information. Therefore, the antenna is an essential role in the wireless transmission system.

However, the electromagnetic interference (EMI) is inevitable when the antenna works in cooperation with a high-frequency circuit. Thus, how to solve the EMI problem has become an important issue. The EMI means the induced electromagnetic energy in different frequencies or a band caused by intermittent or continuous voltage/current variations in a working electronic apparatus. In this case, the related circuit can emit the electromagnetic energy to the near space. In other words, the EMI can interfere with another electronic apparatus by conduction through a conductor or radiation through air. At present, there are several solutions for preventing the EMI, and one of the solutions is to shield the EMI for avoiding the interference to the electromagnetic signals.

As shown in FIG. 1, a conventional wireless transmission system 1 includes a printed circuit board 11, a shield 12, a high-frequency circuit 13, a monopole antenna 15, and a transmission line 16. The high-frequency circuit 13 and the monopole antenna 15 are installed on one surface 111 of the printed circuit board 11. Besides, the surface 111 of the printed circuit board 11 is further installed with a ground plane 14, a resistor 17 and a capacitor 18. The shield 12 is electrically connected to the ground plane 14 and is fixed on the printed circuit board 11 by welding. The shield 12 covers the high-frequency circuit 13. The monopole antenna 15 is electrically connected to the high-frequency circuit 13 through the transmission line 16.

Since the wireless transmission system 1 has the shield 12 covering the high-frequency circuit 13, the electromagnetic interference between the high-frequency circuit 13 and the monopole antenna 15 can be blocked.

As mentioned above, each of the shield 12, resistor 17 and capacitor 18 has a certain height, so the signal receiving and transmitting of the antenna 15 may be interfered, which results in poor transmission of the antenna. Moreover, if the height of the shield 12 increases, the affection to the antenna becomes larger. In addition, the electronic products are smaller due to the progressive technologies, so that the minimization of the electronic products is a basic objective for all electronic product designers.

It is therefore an important subject of the invention to reduce the affection of the antenna transmission caused by the EMI shield and the periphery electronic elements and to minimize the size of the electronic product with the EMI shield.

### SUMMARY OF THE INVENTION

In view of the foregoing, the invention is to provide a co-construction with an antenna and an EMI shield that can enhance the antenna transmission efficiency and minimize the size of the electronic product with the EMI shield.

To achieve the above, a co-construction of the invention includes a shield and a first antenna. In the invention, the shield has a first hole, and the first antenna has a first radiator, a first ground point and a first feeding point. The first ground point is electrically connected to the first radiator and the shield respectively. The first feeding point extends from one side of the first radiator and passes through the shield via the first hole.

To achieve the above, the invention also discloses a co-construction with an antenna function and an EMI shielding function, which is electrically connected with a printed circuit board (PCB). A radio frequency circuit having a high frequency element is disposed on the PCB. The co-construction includes a shield and a first antenna. The shield has a first hole. The first antenna has a first radiator, a first ground point and a first feeding point. The first ground point is electrically connected to the first radiator and shield respectively. The first feeding point extends from one side of the first radiator and passes through the shield via the first hole to electrically connect to the radio frequency circuit of the PCB.

As mentioned above, the invention is to integrate the antenna and shield into a co-construction. Compared with the prior art, which installs the antenna and the shield separately on the printed circuit board, the invention can efficiently prevent other electronic elements from being affected by the shield. In other words, the affection of the signal transmission of the antenna caused by the shield can be reduced, so that the efficiency of the antenna can be increased. Furthermore, since the co-construction includes the antenna and the shield, the area of the printed circuit board for the antenna is unnecessary. Accordingly, the minimization of the electronic product can be achieved due to the co-construction.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing a conventional wireless transmission system;

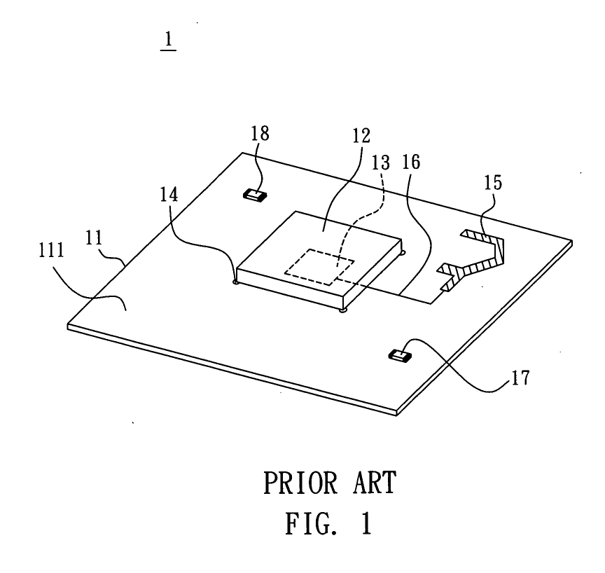

FIG. 2 is a schematic diagram showing a co-construction with an antenna and an EMI shield according to a preferred embodiment of the invention; and

FIG. 3 is another schematic diagram showing the co-construction with an antenna and an EMI shield according to the embodiment of the invention.

### DETAILED DESCRIPTION OF THE INVENTION

The present invention will be apparent from the following detailed description, which proceeds with reference to the accompanying drawings, wherein the same references relate to the same elements.

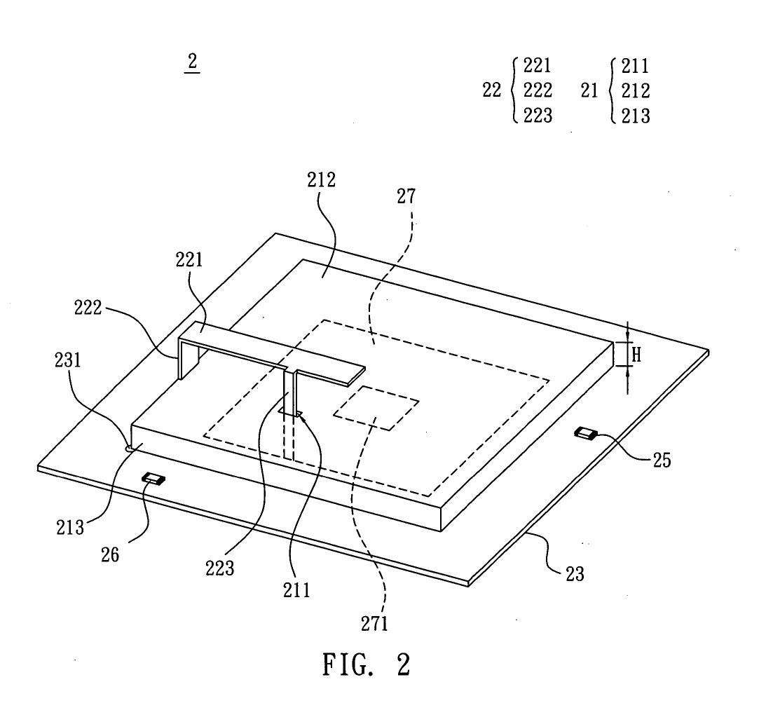

With reference to FIG. 2, a co-construction 2 according to a preferred embodiment of the invention includes a shield 21 and a first antenna 22. In the embodiment, the first antenna 22 and the shield 21 are integrally formed. The first antenna 22 can be an inverted-F antenna or a shorted patch antenna.

The shield 21 has a first hole 211. In the current embodiment, the shield 21 includes a major shielding portion 212 and a minor shielding portion 213. The minor shielding portion 213 is disposed annularly around the major shielding portion 212. The first hole 211 is located on the major shielding portion 212. For the minimized wireless transmission system, the minor 213 has a height H ranged from 1.5 mm to 40 mm.

In the embodiment, the shield 21 is fixed on a printed circuit board 23 by way of screwing, wedging, or welding. The shield 21 is electrically connected to a ground plane 231 of the printed circuit board 23. The printed circuit board 23 is installed with at least one resistor 25, at least one capacitor 26 and a radio frequency (RF) circuit 27, including a high-frequency component 271. Of course, the high-frequency component 271 is unnecessary to be one part of the RF circuit 27. In this embodiment, because the RF circuit 27 and the high-frequency component 271 may cause EMI much easier, and are easily interfered by external EMI, the shield 21 covers them for blocking the EMI.

The first antenna 22 has a first radiator 221, a first ground point 222 and a first feeding point 223. In this case, the first ground point 222 is disposed between the first radiator 221 and the shield 21. In the embodiment, the first ground point 222 is electrically connected to the shield 21 and the first radiator 221, and the first feeding point 223 extends from one side of the first radiator 221 and passes through the shield 21 via the first hole 211.

In the present embodiment, the first feeding point 223 passes through the first hole 211 to electrically connect to the RF circuit 27 of the printed circuit board 23. The signal transmitted by the RF circuit 27 is emitted by the first radiator 221 through the first feeding point 223. In addition, the first radiator 221 receives external signal and then the signal is sent to the RF circuit 27 through the first feeding point 223.

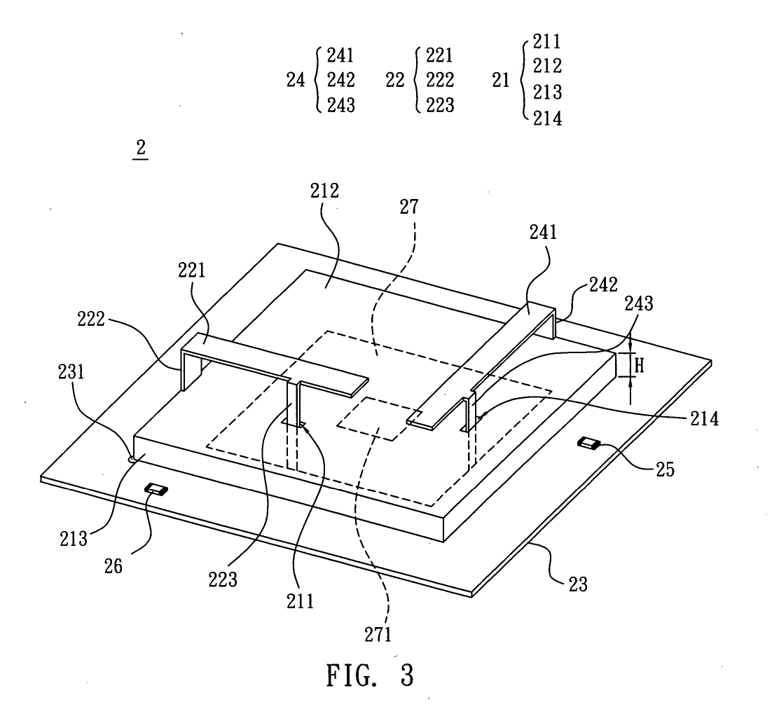

With reference to FIG. 3, the co-construction 2 of the embodiment further includes a second antenna 24. In this embodiment, the second antenna 24 has the same structure and features as the first antenna 22, so the detailed descriptions are omitted. The second antenna 24 includes a second radiator 241, a second ground point 242, and a second feeding point 243. The second ground point 242 extends from one side of the shield 21, and the second feeding point 243 passes through the second hole 241 of the shield 21 and electrically connects to the RF circuit 27. In this embodiment, the shield 21, the first antenna 22 and the second antenna 24 are integrally formed.

In summary, the invention is to integrate the antenna and shield into a co-construction. Compared with the prior art, which installs the antenna and the shield separately on the printed circuit board, the invention can efficiently prevent other electronic elements from being affected by the shield. In other words, the affection of the signal transmission of the antenna caused by the shield can be reduced, so that the efficiency of the antenna can be increased. Furthermore, since the co-construction includes the antenna and the shield, the area of the printed circuit board for the antenna is unnecessary. Accordingly, the minimization of the electronic product can be achieved due to the co-construction.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A co-construction, comprising:
a shield having a first hole; and
a first antenna having a first radiator, a first ground point and a first feeding point, wherein the first ground point is electrically connected to the first radiator and the shield respectively, and the first feeding point extends from one side of the first radiator and passes through the shield via the first hole.

2. The co-construction of claim 1, wherein the first antenna and the shield are integrally formed.

3. The co-construction of claim 1, wherein the shield is fixed on a printed circuit board by way of screwing, wedging, or welding.

4. The co-construction of claim 3, wherein the shield is electrically connected to a ground plane of the printed circuit board.

5. The co-construction of claim 3, wherein the shield further comprises:
a major shielding portion; and
a minor shielding portion disposed annularly around the major shielding portion.

6. The co-construction of claim 5, wherein the minor shielding portion has a height ranged from 1.5 mm to 40 mm.

7. The co-construction of claim 3, wherein the first feeding point passes through the first hole of the shield and electrically connects to a radio frequency (RF) circuit of the printed circuit board.

8. The co-construction of claim 7, wherein the RF circuit comprises a high frequency component.

9. The co-construction of claim 1, further comprising:
a second antenna having a second radiator, a second ground point and a second feeding point, wherein the second ground point extends between the second radiator and the shield.

10. The co-construction of claim 9, wherein the second feeding point extends from one side of the second radiator.

11. The co-construction of claim 9, wherein the shield further has a second hole, and the second feeding point of the second antenna passes through the shield via the second hole.

12. The co-construction of claim 9, wherein the second feeding point passes through the second hole of the shield and electrically connects to a radio frequency (RF) circuit of the printed circuit board.

13. The co-construction of claim 12, wherein the RF circuit comprises a high frequency component.

14. The co-construction of claim 9, wherein the shield, the first antenna and the second antenna are integrally formed.

15. A co-construction electrically connected with a printed circuit board, wherein a radio frequency circuit having a high frequency element is disposed on the printed circuit board, the co-construction comprising:
a shield having a first hole, wherein the shield is fixed on the printed circuit board; and
a first antenna having a first radiator, a first ground point and a first feeding point, wherein the first ground point is electrically connected to the first radiator and the shield respectively, and the first feeding point extends from one side of the first radiator and passes through the shield via the first hole to electrically connect to the radio frequency circuit of the printed circuit board.

16. The co-construction of claim 15, wherein the first antenna and the shield are integrally formed.

17. The co-construction of claim 15, wherein the shield is fixed on the printed circuit board by way of screwing, wedging, or welding.

18. The co-construction of claim 17, wherein the shield is electrically connected to a ground plane of the printed circuit board.

19. The co-construction of claim 17, wherein the shield further comprises:
a major shielding portion; and
a minor shielding portion disposed annularly around the major shielding portion.

20. The co-construction of claim 19, wherein the minor shielding portion has a height ranged from 1.5 mm to 40 mm.

21. The co-construction of claim 15, further comprising:
a second antenna having a second radiator, a second ground point and a second feeding point, wherein the second ground point extends between the second radiator and the shield.

22. The co-construction of claim 21, wherein the second feeding point extends from one side of the second radiator.

23. The co-construction of claim 21, wherein the shield further has a second hole, and the second feeding point of the second antenna passes through the shield via the second hole.

24. The co-construction of claim 21, wherein the second feeding point passes through the second hole of the shield and electrically connects to a radio frequency (RF) circuit of the printed circuit board.

25. The co-construction of claim 21, wherein the shield, the first antenna and the second antenna are integrally formed.
